(19) United States
(12) Patent Application Publication
(10) Pub. No.: US 2008/0081237 A1
(43) Pub. Date: Apr. 3, 2008

(54) POWER GENERATION SYSTEM

(75) Inventor: Akiyoshi Yokoi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/852,062

(22) Filed: Sep. 7, 2007

(30) Foreign Application Priority Data
Oct. 3, 2006 (JP) 2006-271462

(51) Int. Cl. H01M 8/24; H01M 2/00

(52) U.S. Cl. 429/24; 429/22; 429/34

(57) ABSTRACT

The present invention provides a power generation system including: a fuel supply device; a first power generation device and a second power generation device for performing power generation by using a fuel supplied by the fuel supply device; a fuel path connecting the fuel supply device to the first power generation device and the second power generation device, for supplying the fuel; and a fuel control device including a normally closed valve provided in the fuel flow path and opened by an output of the first power generation device, in which the fuel can be supplied from the fuel supply device to the second power generation device through the normally closed valve opened by the output of the first power generation device. According to the system, stable power generation can be performed and downsizing can be achieved.

### BACKGROUND OF THE INVENTION

1. Field of the Invention

The present invention relates to a power generation system.

2. Description of the Related Art

Among power generation systems, fuel cells have such a potential that an amount of energy, which can be supplied per unit, is about several to ten times that of conventional batteries.

There is such an expectation for the fuel cells that by continuously charging the fuel cell with a fuel, a small electronic equipment such as a mobile phone and a notebook personal computer can continuously be used for a long time.

The fuel cell has a structure in which a fuel electrode including a catalyst and an oxidizer electrode including a catalyst are arranged on opposite surfaces of an electrolyte membrane, respectively.

While a fuel such as a hydrogen gas stored in a hydrogen storage alloy tank or the like is supplied to the fuel electrode side, an oxidizer such as oxygen is supplied to the oxidizer electrode side, thereby electrochemically reacting those reactants through the electrolyte membrane to generate electric power.

Conventionally, in order to stably drive the fuel cell, various system structures are developed.

Of those system structures, as a system utilizing a part of electric power of the fuel cell, for stably driving a device in accordance with load characteristics of the device, Japanese Patent Application Laid-Open No. 2001-229950 proposes a system for preventing overdischarge of a secondary battery used for driving auxiliary devices or the like required for starting up a fuel cell stack.

In the system, to achieve a structure in which the fuel cell stack is divided into two parts, and only one fuel cell can selectively be actuated, electric power is supplied from the fuel cell to the secondary battery, thereby preventing overdischarge of the secondary battery used at the time of actuating the fuel cell.

Further, National Publication No. (of the translated version of PCT application) 2002-520778 proposes a sensor cell having a structure with which, depending on a use environment such as electric response or temperature response, a part of the plurality of fuel cells is changed in its output characteristics so that the sensor cell can function as a sensor and can stably be driven.

However, the fuel cell system according to Japanese Patent Application Laid-Open No. 2001-229950 has a structure in which, in order to drive auxiliary devices or the like required for actuating the fuel cell stack, a secondary battery is used separately from the fuel cell, so the structure is unfavorable for downsizing.

That is, the secondary battery is required separately from the fuel cell, so there are needed a bypass for controlling fuel supply to the fuel cell, a flow path switching device, a control device for controlling the flow path switching device, and the like, so the structure is unfavorable for a power generation system for small electronic equipments.

Further, in National Publication No. (of the translated version of PCT application) 2002-520778, a part of the fuel cell is structured to function as a sensor single body. However, measurement unit for obtaining a voltage value, a current value, or the like through a measurement and determination unit for comparing the obtained value and a threshold value are required.

Accordingly, the structure requires spaces for installing the measurement unit and the determination unit, so the structure is unfavorable for the power generation system for small electronic equipments.

### SUMMARY OF THE INVENTION

The present invention is directed to a power generation system capable of performing stable power generation and achieving downsizing.

The present invention provides the power generation system structured as described below.

According to the present invention, a power generation system is characterized by including: a fuel supply device; a first power generation device for performing power generation by using a fuel supplied by the fuel supply device; a second power generation device for performing power generation by using the fuel supplied by the fuel supply device; a fuel path connecting the fuel supply device to the first power generation device and the second power generation device, for supplying the fuel; and a fuel control device including a normally closed valve provided in the fuel flow path and opened by an output of the first power generation device, in which the fuel can be supplied from the fuel supply device to the second power generation device through the normally closed valve opened by the output of the first power generation device.

According to the present invention, the power generation system is characterized in that the first power generation device and the second power generation device are connected in series to each other by the fuel path.

According to the present invention, the power generation system is characterized in that the first power generation device and the second power generation device are connected in parallel to each other by the fuel path.

According to the present invention, the power generation system is characterized in that, in the fuel control device, the normally closed valve is opened when the output of the first power generation device becomes higher than a predetermined threshold value, and the normally closed valve is closed when the output of the first power generation device becomes lower than the predetermined threshold value.

According to the present invention, the power generation system is characterized in that the normally closed valve is closed when the output of the first power generation device becomes lower than the predetermined threshold value depending on an environmental condition.

According to the present invention, the power generation system is characterized in that the environmental condition in which the output of the first power generation device is lower than the predetermined threshold value is one of abnormally high temperature condition and abnormally low humidity condition.

According to the present invention, the power generation system is characterized in that one of the first power generation device and the second power generation device includes a fuel cell.

According to the present invention, the power generation system is characterized in that the fuel cell includes a fuel cell stack including at least one fuel cell unit.

According to the present invention, the power generation system capable of performing stable power generation and downsizing can be realized.

Further features of the present invention will become apparent from the following description of exemplary embodiments with reference to the attached drawings.

### BRIEF DESCRIPTION OF THE DRAWINGS

FIG. 1 is a block diagram for describing a structure of a fuel cell apparatus according to Embodiment 1 of the present invention.

FIG. 2 is a view for describing a mounting state of the fuel cell apparatus with respect to a casing of an electronic equipment according to Embodiment 1 of the present invention.

FIG. 3 is a diagram for describing a structure of a fuel cell unit of the fuel cell apparatus according to Embodiment 1 of the present invention.

FIG. 4 is a block diagram for describing a structure of an electronic equipment on which the fuel cell apparatus according to Embodiment 1 of the present invention is mounted.

FIG. 5 is a diagram for describing an operating state of the fuel cell unit according to Embodiment 1 of the present invention.

FIG. 6 is a sectional view illustrating a structure of a second fuel cell according to Embodiment 1 of the present invention.

FIG. 7 is a perspective view illustrating the structure of the second fuel cell according to Embodiment 1 of the present invention.

FIG. 8 is a flow chart for describing an actuation operation of the fuel cell according to Embodiment 1 of the present invention.

FIG. 9 is a flow chart for describing a stopping operation of the fuel cell according to Embodiment 1 of the present invention.

FIG. 10 is a graph of I-V characteristics of a fuel cell for describing a structural example in which a first fuel cell is used as an environment sensor according to Embodiment 2 of the present invention.

FIG. 11 is a graph of voltage characteristics of the fuel cell for describing the structural example in which the first fuel cell is used as the environment sensor according to Embodiment 2 of the present invention.

FIG. 12 is a block diagram for describing a structure of a fuel cell apparatus according to Embodiment 3 of the present invention.

### DESCRIPTION OF THE EMBODIMENTS

A description will be made of a power generation system according to an embodiment of the present invention.

According to this embodiment, there is provided a power generation system including: a first power generation device and a second power generation device for generating power by using a fuel supply device and a fuel; a fuel path connecting the fuel supply device to the first power generation device and second power generation device, for supplying the fuel; and a fuel control device including a normally closed valve provided in the fuel path between the second power generation device and the fuel supply device, in which the fuel path between the fuel supply device and the normally closed valve is connected to the first power generation device, and the normally closed valve is structured as a valve opened by an output of the first power generation device.

According to this embodiment as described above, in order to control fuel supply to the second power generation device, the normally closed valve is structured so as to be opened by the output of the first power generation device, thereby eliminating a need for preparing a new power source device for actuation in a case of supplying power to an electronic equipment or the like.

Further, when an output of the first power generation device is extremely reduced in an abnormal state, the normally closed valve is automatically closed, whereby the fuel supply to the second power generation device can be stopped.

As a result, the power generation system with high stability can be achieved employing the small number of components. Further, there can be realized a power generation device which is compatible with the small electronic equipments and which can stably generate power.

Note that, the power generation system according to this embodiment is not limited to the above-mentioned structure. Another embodiment can be realized in which a part or the whole of the structure of the power generation system is replaced with its alternative structure. For example, a fuel cell apparatus is structured as the power generation system, and the whole of the fuel cell apparatus in which a fuel cell stack and a fuel tank are integrally connected to each other can be made detachable from a casing of the electronic equipment.

Alternatively, the fuel cell stack may be incorporated into the casing side of the electronic equipment so that only the fuel tank is detachable from the casing of the electronic equipment.

Further, according to the following embodiments, a description will be made of structural examples in which oxygen in an atmosphere is taken in to be utilized as an oxidizer. However, as the oxidizer, another gaseous or liquid substance exerting an oxidative effect corresponding to oxygen may be used.

Further, in a case where oxygen is used as the oxidizer, instead of taking in the oxygen from the atmosphere, the oxygen may be supplied from an oxygen gas cylinder or an oxygen gas generation device by connecting the oxygen gas cylinder or the oxygen gas generation device to the fuel cell stack.

Further, a description will be made of an example in which the present invention is applied to a fuel cell of a polymer electrolyte type using a hydrogen gas. However, the fuel cell is not limited to this type. With a fuel cell using another fuel (for example, methanol) or a fuel cell of another type (for example, a solid oxide type or a phosphoric acid type), the same effect can be obtained.

Further, as long as the power generation system performs power generation by receiving supply of a fuel, the power generation system is not limited to the fuel cell. For example, the power generation system may be a power generation system with a micro engine utilizing a microturbine, which is formed by using a MEMS technology.

In the following, embodiments of the present invention will be described further in detail with reference to the drawings.

### Embodiment 1

In Embodiment 1 of the present invention, a description will be made of a fuel cell apparatus to which a fuel cell system according to the present invention is applied.

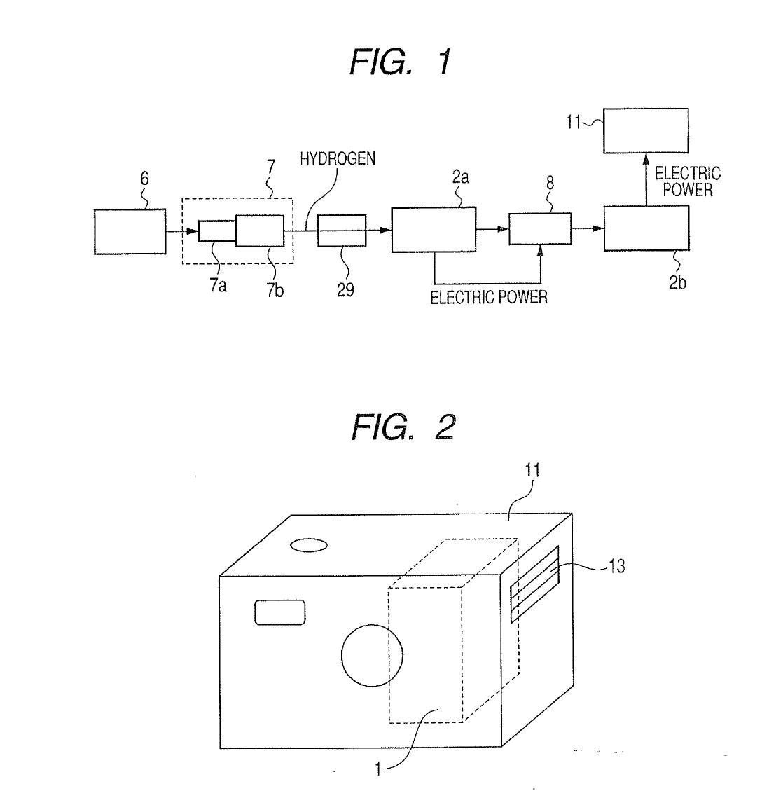

FIG. 1 illustrates a block diagram for describing a structure of the fuel cell apparatus according to this embodiment.

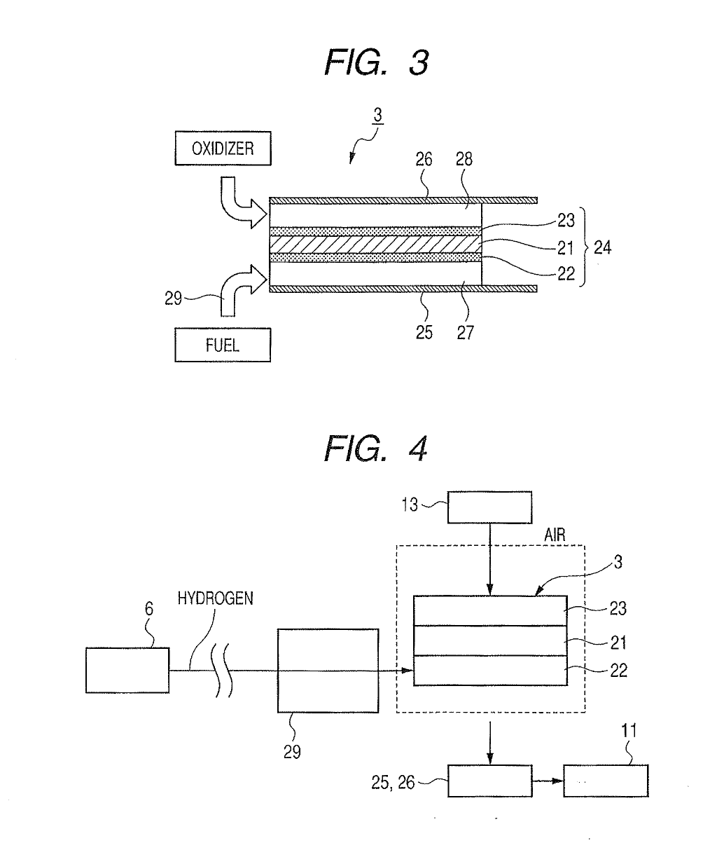

FIG. 2 is a view for describing a mounting state of the fuel cell apparatus on a casing of an electronic equipment. FIG. 3 is a diagram for describing a structure of a fuel cell unit of the fuel cell apparatus.

FIG. 4 is a block diagram for describing a structure of the electronic equipment on which the fuel cell apparatus is mounted.

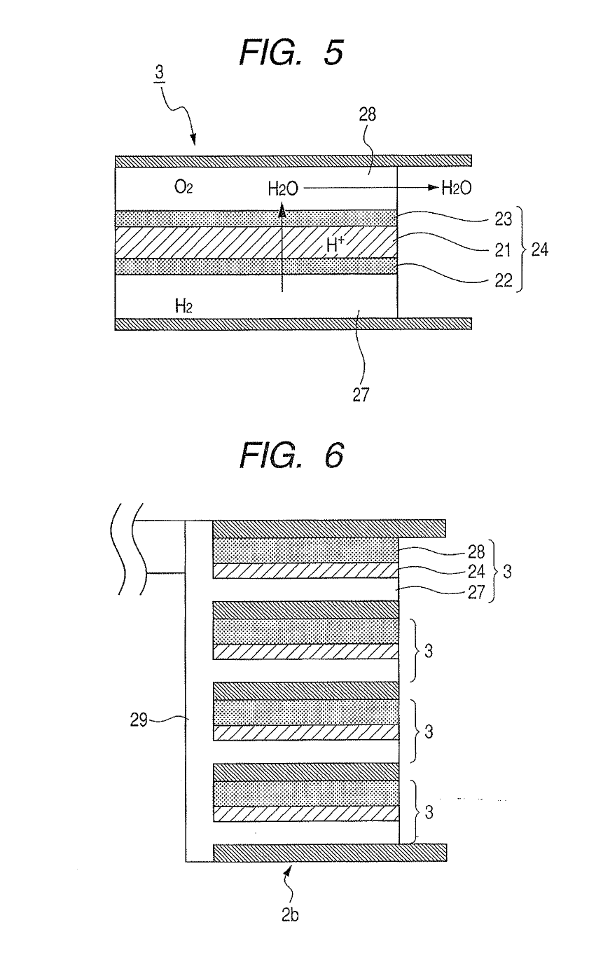

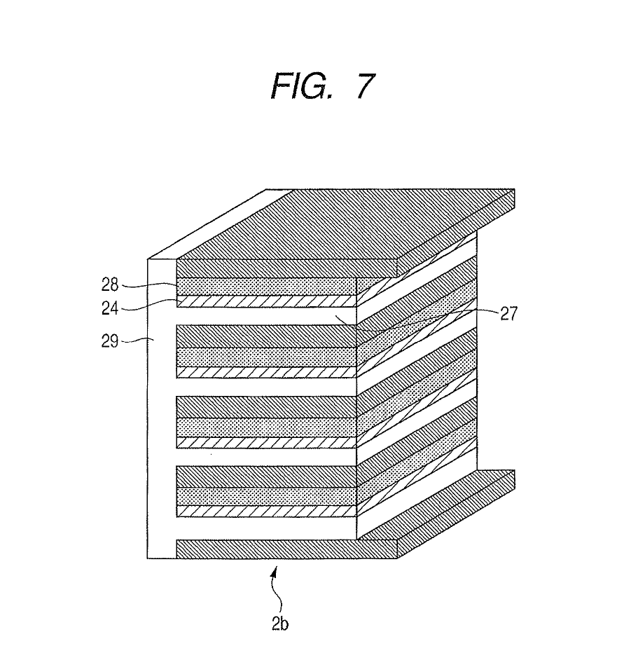

FIG. 5 is a diagram for describing an operating state of the fuel cell unit. FIG. 6 is a sectional view of a second fuel cell. FIG. 7 is a perspective view of the second fuel cell.

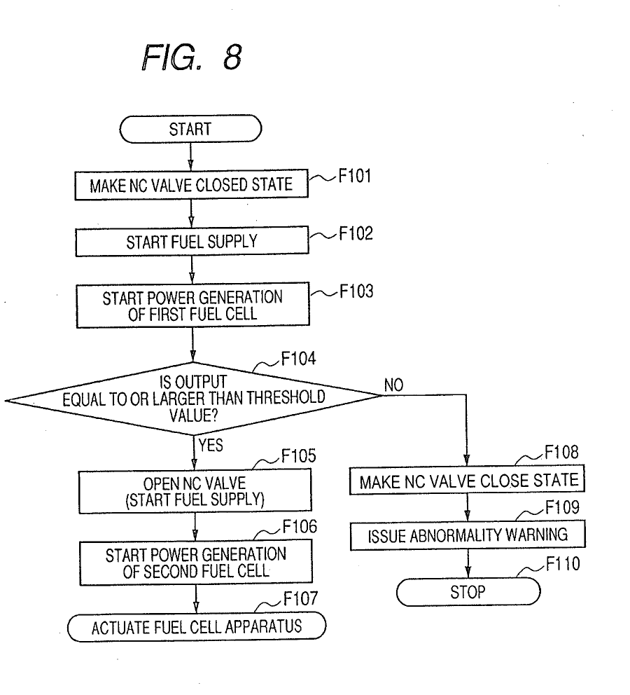

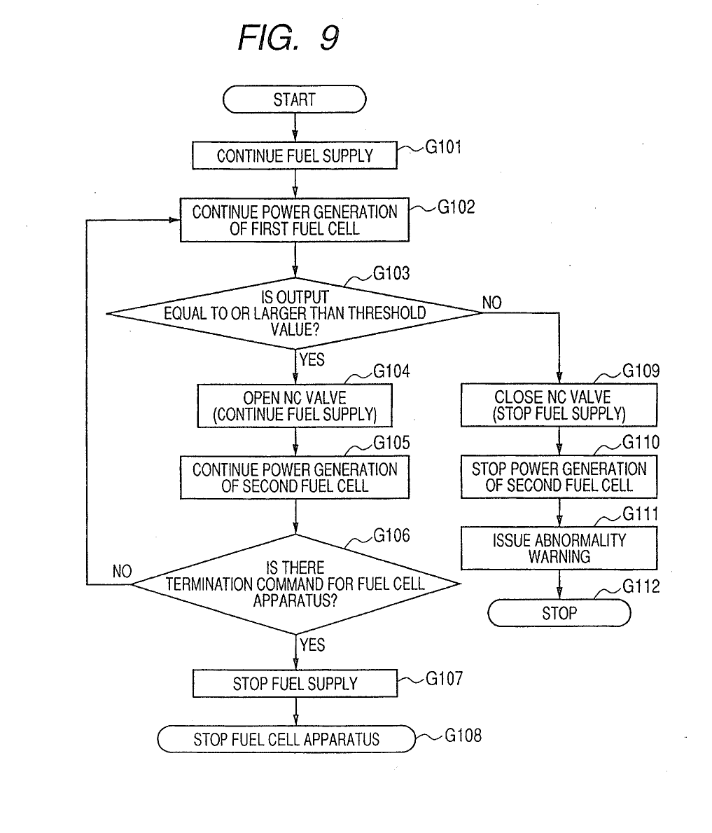

FIG. 8 is a flow chart for describing an actuation operation of the fuel cell. FIG. 9 is a flow chart for describing a stopping operation of the fuel cell.

In FIGS. 1, 2, and 3, there are provided a fuel cell apparatus 1, a first fuel cell 2a, a second fuel cell 2b, a fuel cell unit 3, and a fuel tank 6.

There are provided a joint 7, a plug 7a, a socket 7b, a normally closed valve (NC valve) 8, an electronic equipment 11, and an air hole 13. Note that, also in FIGS. 4 to 12, the same components are denoted by the same reference symbols.

The fuel cell apparatus 1 according to this embodiment has a structure as illustrated in FIG. 1, in which the first fuel cell 2a is detachably connected to the fuel tank 6 by the joint 7 including the plug 7a and the socket 7b. On a downstream of the first fuel cell 2a, a fuel path 29 connects the first fuel cell 2a to the second fuel cell 2b through the normally closed valve (hereinafter, referred to as NC valve) in series.

With this connection in series, the single fuel path 29 can be used for both the first fuel cell 2a and the second fuel cell 2b. Therefore, downsizing of the fuel cell apparatus as a whole is enabled.

Further, as illustrated in FIG. 2, the fuel cell apparatus 1 according to this embodiment is inserted from a lower portion of a casing of an electronic equipment (digital camera) 11 so as to be detachably mounted on the casing.

The casing of the electronic equipment 11 is provided with the air hole 13 for supplying an oxidizer (oxygen in the atmosphere) to the fuel cell apparatus 1.

Further, the first fuel cell 2a and the second fuel cell 2b each include the fuel cell unit 3 for taking out a current by electrochemically reacting a hydrogen gas and oxygen with each other.

The fuel cell unit 3 includes, as illustrated in FIG. 3, a diffusion layer 28 for supplying an oxidizer and discharging water vapor, a diffusion layer 27 for supplying a hydrogen gas serving as a fuel, and an MEA (membrane electrode assembly) 24 sandwiched by the diffusion layer 28 and the diffusion layer 27.

The diffusion layers 27 for supplying the hydrogen gas to the fuel cell units 3 are joined in the fuel path 29. The fuel path 29 communicates with the fuel tank 6.

The diffusion layer 27 is made of a porous conductive material having air permeability, allows a hydrogen gas molecule to diffuse and permeate into an entire surface of a fuel electrode 22 of the MEA 24, and serves as a current path which allows electrons of the fuel electrode 22 to escape to an electrode 25 to take out the electrons.

The diffusion layer 28 is also made of a porous conductive material having air permeability, allows oxygen gas molecules to diffuse and permeate into an entire surface of an oxidizer electrode 23 of the MEA 24, and serves as a current path which supplies electrons to the oxidizer electrode 23 from an outside.

The MEA 24 has a structure in which a polymer electrolyte membrane 21 is sandwiched between the fuel electrode 22 and the oxidizer electrode 23.

The fuel electrode 22 is an air permeable thin film layer, in which a platinum catalyst is diffused, ionizes the hydrogen gas by decomposing the hydrogen gas into hydrogen atoms, and feeds hydrogen ions to the polymer electrolyte membrane 21.

The oxidizer electrode 23 is an air permeable thin film layer, in which a platinum catalyst is diffused, and generates water molecules by reacting the oxygen gas with the hydrogen ions received from the polymer electrolyte membrane 21.

The polymer electrolyte membrane 21 allows the hydrogen ions received from the fuel electrode 22 to move therethrough to deliver the hydrogen ions to the oxidizer electrode 23 and prevents direct movement of the electrons between the fuel electrode 22 and the oxidizer electrode 23.

Accordingly, the hydrogen gas, that is, the fuel stored in the fuel tank 6 (FIG. 1) passes through the fuel path 29 to be supplied to the fuel electrode 22 as indicated by an arrow.

On the other hand, to the oxidizer electrode 23, oxygen in the atmosphere taken in through the air hole 13 (FIG. 2) is supplied.

As illustrated in FIG. 5, the hydrogen gas passes through the diffusion layer 27 to permeate into the fuel electrode 22 and comes into contact with the catalyst included in the fuel electrode 22 to cause a hydrogen ionization reaction.

The hydrogen ions pass through the polymer electrolyte membrane 21. On the other hand, oxygen taken in from the atmosphere passes through the diffusion layer 28 to permeate into the oxidizer electrode 23. Under presence of catalyst atoms included in the oxidizer electrode 23, the oxygen is bound with the hydrogen ions which have passed through the polymer electrolyte membrane 21, thereby generating water molecules.

As illustrated in FIG. 4, with the above-mentioned electrochemical reaction, electrons of the hydrogen molecules are taken out from the electrode 25 and are introduced to an electrode 26 through an external electric circuit, thereby generating water molecules.

As a result, in the external electric circuit, current corresponding to an electrochemical energy difference between the hydrogen gas and the water is taken out.

Next, a description will be made of the first fuel cell according to this embodiment.

The first fuel cell 2a includes the fuel cell unit 3 as described above.

When the fuel tank 6 is connected to the fuel cell apparatus 1 by the joint 7, the hydrogen gas in the fuel tank 6 is supplied to the fuel electrode 22 through the joint 7 after passing through the diffusion layer 27 (FIG. 3).

On the other hand, air as the oxidizer is supplied to the diffusion layer 28 (FIG. 3) of each of the fuel cell units 3 through the air hole 13. Binding reaction between hydrogen ions and oxygen as described above then occurs, and power generation is performed by the first fuel cell 2a to supply electric power to the NC valve 8.

In this case, the first fuel cell 2a is desirably placed in the same environment as that in which the second fuel cell 2b is placed.

Next, a description will be made of the NC valve according to this embodiment.

Between the first fuel cell 2a and the second fuel cell 2b, the fuel path 29 is in a connected state by the NC valve 8. The NC valve 8 is always closed in a state where electric power is not supplied. In a state where the NC valve 8 is closed, a flow path of the hydrogen gas to the second fuel cell 2b is shut off. The first fuel cell 2a performs power generation and supplies a predetermined electric power to the NC valve 8, thereby opening the NC valve 8 to allow the hydrogen gas to be supplied to the second fuel cell 2b. In this case, in order to achieve a structure in which the first fuel cell 2a is directly connected to the NC valve 8 without an intermediation of a special control device, a value of the electric power of the first fuel cell 2a by which the NC valve 8 is opened is set to be equal to or larger than a predetermined threshold value of the first fuel cell 2a.

In setting the threshold value, a lower limit value of the electric power, which is supplied by the second fuel cell 2b and by which the electronic equipment 11 can be stably driven, is set to be equal to or larger than a value which has been converted for the first fuel cell 2a.

Specifically, in this embodiment, the first fuel cell 2a and the second fuel cell 2b include the fuel cell unit(s) 3 of the same structure, respectively. There are used the single fuel cell unit 3 for the first fuel cell 2a and the four fuel cell units 3 for the second fuel cells 2b, the four fuel cell units 3 being stacked on each other. Thus, a voltage value of the fuel cell 2a is ¼ that of the fuel cell 2b. A value of ¼ the lower limit value of the electric power, by which the electronic equipment 11 can be stably driven, is set to a threshold value of the NC valve 8.

Further, as the NC valve 8, a piezoelectric element valve or the like of a solenoid type or bimorph type is used.

Next, a description will be made of the second fuel cell according to this embodiment.

As illustrated in FIGS. 6 and 7, the second fuel cell 2b is structured by electrically connecting the plurality of fuel cell units 3 to each other in series in accordance with a load of the electronic equipment 11. Each of the fuel cell units 3 has a structure illustrated in FIG. 3.

FIG. 6 illustrates an example in which the four fuel cell units 3 are electrically connected to each other. The fuel electrodes 22 (FIG. 3) of the four fuel cell units 3 communicate with the fuel path 29 through the diffusion layers 27.

When hydrogen is consumed by the second fuel cell 2b, the hydrogen gas in the fuel tank 6 is supplied to the fuel electrode 22 (FIG. 3) through the diffusion layer 27 of each of the fuel cell units 3 through the first fuel cell 2a and the NC valve 8.

Air as the oxidizer is supplied to the diffusion layer 28 of each of the fuel cell units 3 through the air hole 13. The binding reaction between hydrogen ions and oxygen occurs, and electric power is supplied to the electronic equipment 11 electrically connected to the fuel cells 3.

Next, a description will be made of an actuation operation in the fuel cell apparatus according to this embodiment.

FIG. 8 illustrates a flow chart for describing the actuation operation.

In a state where the fuel gas is not supplied to the first fuel cell 2a of the fuel cell apparatus 1, the NC valve 8 is in a closed state (Step F101).

Next, when the supply of the fuel gas from the fuel tank 6 is started (Step F102), the fuel gas is supplied to the first fuel cell 2a to start power generation (Step F103).

Next, in Step F104, when an output of the first fuel cell 2a is equal to or larger than a predetermined threshold value, the NC valve 8 is opened and the fuel gas is supplied to the second fuel cell 2b (Step F105) to allow the second fuel cell 2b to start power generation (Step F106).

The fuel cell apparatus 1 is then actuated (Step F107), and electric power is supplied to the electronic equipment 11.

On the other hand, when the fuel cell apparatus 1 is in an abnormal condition such as abnormal environment or the like and the output of the first fuel cell 2a is lower than the predetermined threshold value in Step F104, the NC valve 8 maintains the closed state (Step F108).

As a result, the fuel gas is not supplied to the second fuel cell 2b, so electric power is not supplied to the electronic equipment 11.

In this case, abnormality warning is issued to alert a user (Step F109), and actuation of the fuel cell apparatus 1 is stopped (Step F110).

Next, a description will be made of a stopping operation when abnormality occurs in the fuel cell apparatus according to this embodiment.

FIG. 9 illustrates a flow chart for describing a stopping operation of the fuel cell.

In FIG. 9, fuel supply to the fuel cell apparatus 1 is continued after the actuation thereof (Step G101), and the power generation of the first fuel cell 2a is continued (Step G102).

When, in Step G103, the output is maintained to be equal to or larger than the predetermined threshold value, the open state of the NC valve 8 is continued (Step G104).

The fuel gas is kept supplied to the second fuel cell 2b, and the power generation of the second fuel cell 2b is continued to supply electric power to the electronic equipment 11 (Step G105).

In a case where an operation of the user moves to the power off operation of the electronic equipment 11 or a standby mode (Step G106), a termination signal is input to the fuel cell apparatus 1, and the operation then moves to a termination mode.

In the termination mode, the fuel supply from the fuel tank 6 is stopped (Step G107), and the fuel cell apparatus 1 is stopped (Step G108).

On the other hand, when the fuel cell apparatus 1 is in an abnormal condition such as abnormal environment or the like and the output of the first fuel cell 2a is lower than the predetermined threshold value in Step G103, even in a case where there is no fuel cell termination command (Step G106), the NC valve 8 is closed (Step G109).

The fuel supply to the second fuel cell 2b is then stopped.

As a result, the power generation of the second fuel cell 2b is stopped (Step G110), the abnormality warning is issued to alert the user (Step G111), and the fuel cell apparatus 1 is stopped (Step G112).

As described above, electric power is supplied by the power generation of the first fuel cell 2a, with the result that opening and closing of the valve for supplying a fuel to the second fuel cell 2b to drive the electronic equipment are performed without using special electric power supply unit such as a secondary battery.

Thus, there can be provided a fuel cell apparatus which has a simple system structure, which can be downsized, and which can be incorporated in a small electronic equipment.

Further, in a case where the fuel cell apparatus 1 is in the abnormal environment and the output of the first fuel cell 2a is abnormally reduced, the NC valve 8 is automatically closed, so the fuel supply to the second fuel cell 2b is stopped.

Accordingly, a fail safe mechanism of a passive type is realized, so the fuel cell apparatus with higher stability can be provided.

The description has been made while the first fuel cell 2a includes the fuel cell unit 3 of the fuel cell. However, the first fuel cell 2a may include a plurality of fuel cell units 3 stacked on each other to constitute a stacked structure.

Further, any apparatus may be used as long as the power generation is performed by using a fuel, and the catalyst combustor using a catalyst may be used.

In the structural example, the one first fuel cell 2a and the one second fuel cell 2b are arranged. However, as long as desired functions and output can be obtained, each of the first fuel cell 2a and the second fuel cell 2b may be obtained by electrically connecting a plurality of stacks.

### Embodiment 2

In Embodiment 2 of the present invention, a description will be made of a structural example in which a first fuel cell is used as an environment sensor.

In this embodiment, the first fuel cell 2a is used as the environment sensor by using change in environmental characteristics of the fuel cell.

As a result, stability against environmental variation can be improved.

As characteristics of the fuel cell, a dry-out phenomenon in which a moisture content in the fuel cell unit is insufficient at high temperature occurs.

Further, as moisture characteristics, when a humidity is low, a membrane resistance of the polymer electrolyte membrane 21 increases, thereby deteriorating performance thereof.

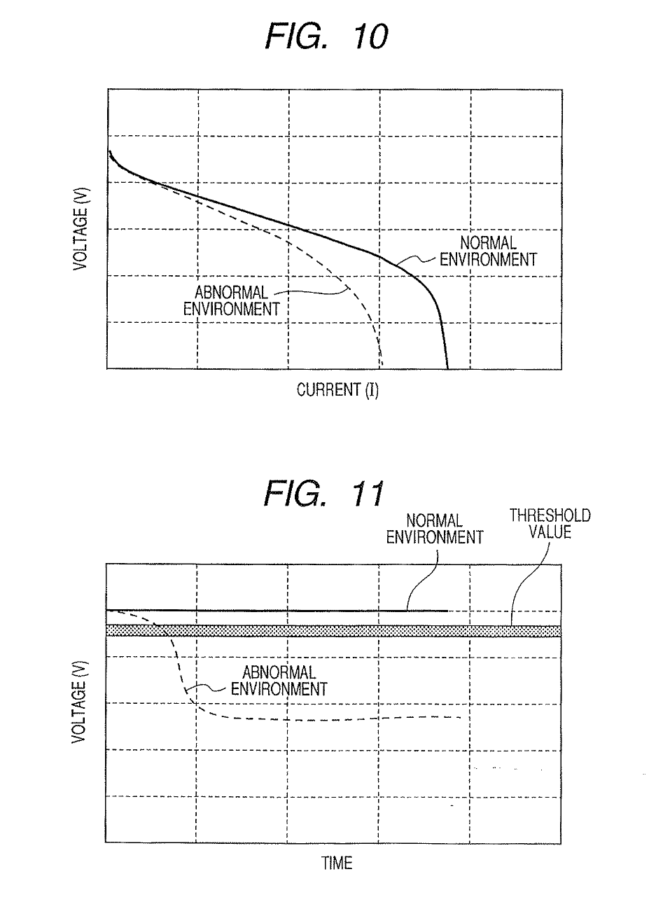

In the abnormal environment, as illustrated in a graph of I-V characteristics of FIG. 10, as compared to a line corresponding to a normal environment (solid line), a line corresponding to the abnormal environment (broken line) is remarkably reduced in performance.

In the above-mentioned low humidity or high temperature state, as illustrated in FIG. 11, the voltage characteristics are indicated by the line corresponding to the abnormal environment (broken line) with respect to the line corresponding to the normal environment (solid line).

By utilizing the above-mentioned characteristics, the predetermined threshold value of a voltage for opening the NC valve 8 is set between the line corresponding to the normal environment (solid line) and the line corresponding to the abnormal environment (broken line).

As a result, there can be achieved a structure in which, in abnormally high temperature condition or abnormally low humidity condition, the NC valve 8 is closed, and the fuel supply of the second fuel cell 2b is stopped. Thus, the fuel cell apparatus 1 can be increased in stability against the abnormal environment.

### Embodiment 3

In Embodiment 3 of the present invention, a description will be made of a structural example in which the first fuel cell and the second fuel cell are connected to the fuel path in parallel to each other.

In Embodiment 1 of the present invention, the first fuel cell 2a and the second fuel cell 2b are connected to each other by the fuel path 29 in series, the fuel path 29 being in the connected state by the NC valve 8.

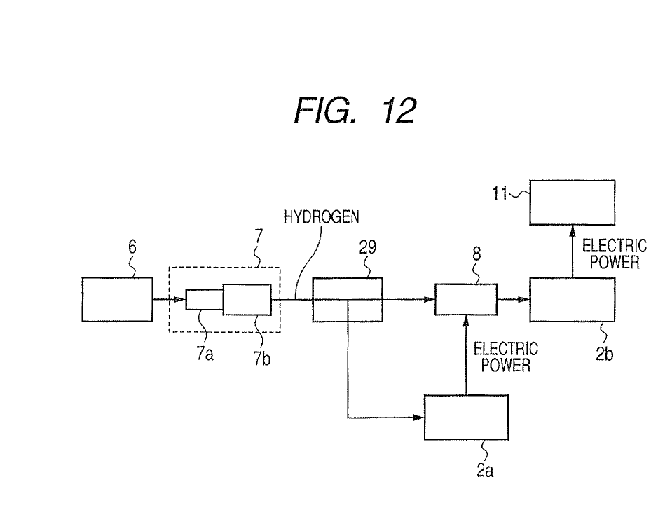

This embodiment employs a structure in which, as illustrated in FIG. 12, the first fuel cell 2a and the second fuel cell 2b are connected to the fuel tank 6 in parallel thereto through the fuel path 29. The NC valve 8 is connected to the fuel path 29 and provided between the second fuel cell 2b and the fuel tank 6.

Even with this structure, the same effect as that of Embodiment 1 of the present invention can be obtained.

In this case, by branching the fuel path 29, the second fuel cell 2b can be separated from a supplied gas. Therefore, a pressure or a flow rate of the fuel gas can be adjusted for the first fuel cell 2a.

A smaller amount of the fuel for allowing the first fuel cell 2a to perform power generation is sufficient than that for the second fuel cell 2b. Thus, there is no need for the first fuel cell 2a and the flow path there around to deal with a high voltage and a high flow rate as compared to the serial connection, so the first fuel cell 2a can be simplified, and the downsizing is possible.

Further, a degree of freedom of fuel path arrangement for the first fuel cell 2a is high, so a degree of freedom of a layout design of the fuel cell can be increased.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-271462, filed Oct. 3, 2006, which is hereby incorporated by reference herein in its entirety.

What is claimed is:

1. A power generation system comprising:
a fuel supply device;
a first power generation device for performing power generation by using a fuel supplied by the fuel supply device;
a second power generation device for performing power generation by using the fuel supplied by the fuel supply device;
a fuel path connecting the fuel supply device to the first power generation device and the second power generation device, for supplying the fuel; and
a fuel control device including a normally closed valve provided in the fuel flow path and opened by an output of the first power generation device,
wherein the fuel can be supplied from the fuel supply device to the second power generation device through the normally closed valve opened by the output of the first power generation device.

2. The power generation system according to claim 1, wherein the first power generation device and the second power generation device are connected in series to each other by the fuel path.

3. The power generation system according to claim 1, wherein the first power generation device and the second power generation device are connected in parallel to each other by the fuel path.

4. The power generation system according to claim 1, wherein in the fuel control device, the normally closed valve is opened when the output of the first power generation device becomes higher than a predetermined threshold value, and the normally closed valve is closed when the output of the first power generation device becomes lower than the predetermined threshold value.

5. The power generation system according to claim 4, wherein the normally closed valve is closed when the output of the first power generation device becomes lower than the predetermined threshold value depending on an environmental condition.

6. The power generation system according to claim 5, wherein the environmental condition in which the output of the first power generation device is lower than the predetermined threshold value is one of abnormally high temperature condition and abnormally low humidity condition.

7. The power generation system according to claim 1, wherein one of the first power generation device and the second power generation device comprises a fuel cell.

8. The power generation system according to claim 7, wherein the fuel cell comprises a fuel cell stack including at least one fuel cell unit.
